(19) United States
(12) Patent Application Publication
(10) Pub. No.: US 2005/0122978 A1
(43) Pub. Date: Jun. 9, 2005

(54) Systems and methods for ADSL inverse multiplexing

(76) Inventor: Robert Douglas Nicholson, Cumming, GA (US)

Correspondence Address: SUTHERLAND ASBILL & BRENNAN LLP, 999 PEACHTREE STREET, N.E., ATLANTA, GA, 30309, US

(21) Appl. No.: 10/728,675

(22) Filed: Dec. 5, 2003

(51) Int. Cl. H04L 12/28

(52) U.S. Cl. 370/395.1; 370/536; 370/537

(57) ABSTRACT

Systems and methods utilize inverse multiplexing to deliver a high bit rate service, such as streaming video, concurrently over multiple Asynchronous Digital Subscriber Lines (ADSL). Because ADSL delivery uses conventional telephone lines, and is relatively inexpensive, systems and methods of the present invention aggregate multiple ADSLs to deliver high bit rate service at a much lower cost than using more expensive, higher bit-rate lines, such as T-1 or T-3 lines. Additionally, because ADSL is highly asymmetric, the systems and methods are particularly suited to video delivery.

### FIELD OF THE INVENTION

The present invention generally relates to inverse multiplexing, and more particularly, to systems and methods for inverse multiplexing using Asynchronous Digital Subscriber Lines (ADSL) to achieve high speed communication.

### BACKGROUND OF THE INVENTION

As the information age matures, it is enabled by a number of technological advances, such as the geometric growth of networked computing power and the prevalence of reliable and ubiquitous transmission media. Today's consumers in both the residential and business arena have been acclimated to a more graphical approach to communication. In particular, multimedia applications, which include textual, graphical, image, video, voice and audio information, have become increasingly popular and find usage in science, business, and entertainment.

Whether for video downloads, video conferencing, or news video services at work or broadband video services, video-on-demand, or interactive TV services at home, online users are concerned with the huge qualitative difference in the viewing experience and visual interactivity of online video services. As a result of the demand for multimedia applications, a current challenge is making the bandwidth required for transmitting such multimedia content reliable and inexpensive. Among other things, providing multimedia content such as digital video and digital video services to LAN, wide area network (WAN) and Internet users requires substantial bandwidth between the content provider and end user.

The communication industry has recognized the escalating demand. For instance, cable operator companies are constantly upgrading their cable distribution facilities to increase greatly the available bandwidth to handle online video services and to provide two-way connectivity for interactivity functions for their cable-modem subscribers. Telephone operating companies offer digital subscriber lines (DSL) and satellite distribution companies provide high bandwidth services for viewing media-rich content. Each of these bandwidth distribution systems has the advantage of being “always on” to the subscriber, thereby making their viewing experience as accessible and familiar as turning on the television.

Although the above-described systems have greatly increased the bandwidth available to home users of the Internet and WANs, providing a substantial amount of content, such as high quality video, to one or more end users often requires higher speed networking systems. Cell switching technology, such as Asynchronous Transfer Mode (ATM), was developed by telephone companies (Telcos) in part because of the need to provide a high-speed backbone network for the transport of various types of traffic, including voice, data, image, and video. An ATM network is typically able to provide symmetrical bandwidths to an ATM user at approximately 1.5 Mbps on a T1 line, 44.7 Mbps on a T3 line, and 155 Mbps over a fiber optic OC-3c line.

Unfortunately, Telco high bandwidth systems delivering content at rates of 1 Mbps are very expensive. For instance, a T1 line can cost approximately $400-$700 per month. What is therefore needed are systems and methods for providing reliable, high bandwidth communication paths at low costs.

### BRIEF SUMMARY OF THE INVENTION

Methods and systems of the present invention utilize inverse multiplexing to deliver a high bit rate service, such as streaming video, concurrently over multiple Asynchronous Digital Subscriber Lines (ADSL). Because ADSL delivery uses conventional telephone lines, and is relatively inexpensive, systems and methods of the present invention aggregate multiple ADSLs to deliver high bit rate service at a much lower cost than using more expensive, higher bit-rate symmetrical services, such as T-1 or T-3.

According to one aspect of the present invention, there is disclosed a method for transmitting data from a content provider to a destination. The method includes the steps of providing digital data, inverse-multiplexing the digital data into a plurality of Asynchronous Transfer Mode (ATM) data cells, and identifying at least one transmission path by which the plurality of ATM data cells will be transmitted to a destination. The method further includes the steps of transmitting the plurality of ATM data cells to the destination using, at least in part, a plurality of Asymmetric Digital Subscriber Lines (ADSL), and receiving the ATM data cells at the destination.

According to one aspect of the present invention, the method further includes the step of multiplexing the ATM data cells to reconstruct, at the destination, the digital data. According to another aspect of the present invention, the method may also include the step of displaying the digital data. According to yet another aspect of the present invention, the step of transmitting may include the step of transmitting the plurality of ATM data cells to the destination using, at least in part, an ATM network. The step of transmitting may also include the step of transmitting the plurality of ATM data cells to the destination using, at least in part, a virtual circuit.

According to another aspect of the invention, the method may further include the step of modulating the virtual circuit onto an ADSL. Moreover, the method may also include the step of reconstructing the ATM data cells to reconstruct the digital data using an inverse multiplexing ADSL modem. The step of identifying at least one transmission path may also include the step of identifying at least one transmission path using ATM protocol.

According to another embodiment of the present invention, there is disclosed a system for distributing bandwidth-intensive content. The system includes a content provider operative to provide digital data, and an ATM switch in electrical communication with the content provider, where the ATM switch is operative to inverse-multiplex the digital data into a plurality of data cells. The system also includes at least one predefined transmission path by which the plurality of data cells may be transmitted to a destination, and at least two Asymmetric Digital Subscriber Lines (ADSLs), where the ADSLs are operable to forward the plurality of data cells to the destination.

According to one aspect of the present invention, the system can further include at least one ATM network in communication with the ATM switch, where the ATM network is operable to transmit at least a portion of the digital data via at least one virtual circuit. According to another aspect of the invention, the system can also include at least one ADSL modem, where the at least one ADSL modem is operable to reconstruct the plurality of data cells. According to yet another aspect of the present invention, the system may further include at least one DSLAM, where the at least one DSLAM is operable to receive data from a virtual circuit and to modulate the virtual circuit onto an ADSL path.

Additionally, the content provider may include a video on demand server, and the content provider and ATM switch may be in communication via a local area network. According to yet another aspect of the invention, the aggregate transmission speed of the at least two ADSLs at least equals the transmission speed of the local area network.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a block diagram illustrating a system in which multiple T1 lines are aggregated, according to the prior art.

FIG. 2 shows a block diagram illustrating a system in which ADSL lines are aggregated, according to one embodiment of the present invention.

FIG. 3 shows a block diagram illustrating a ATU-R for multiplexing data received via aggregated ADSL lines, according to one embodiment of the present invention.

FIG. 4 shows a block diagram flow chart illustrating a method in which digital content is transmitted via aggregated ADSL lines, according to one embodiment of the present invention.

### DETAILED DESCRIPTION OF THE INVENTION

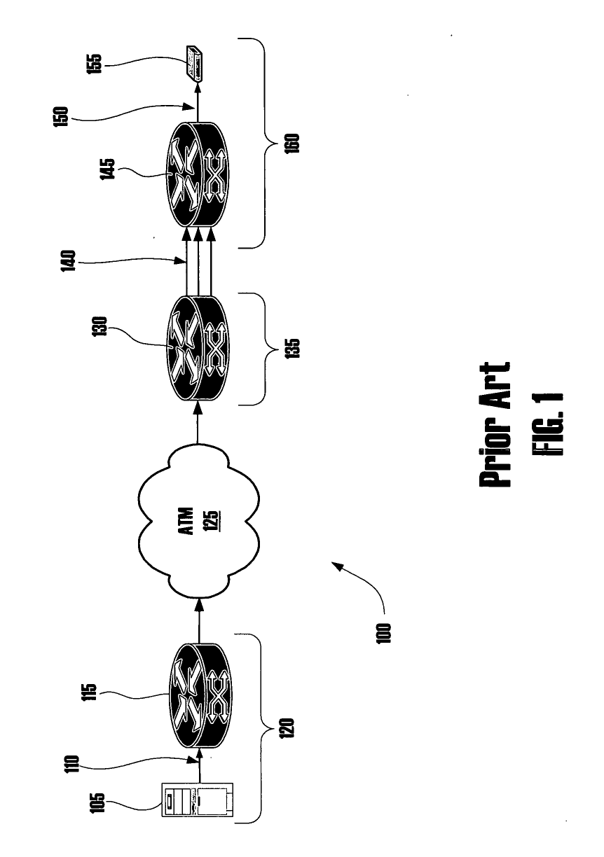

FIG. 1 shows a block diagram of a content distribution system 100 of the prior art. The system 100 includes three T1 lines 140 aggregated to generate an effective 4.5 Megabits per second (Mbps) communication path. In general, in order for content to be inverse multiplexed over multiple paths, devices at each end of the connection must establish a mechanism for breaking up the content at the source into packets and recombining the packets at the destination to recover the content.

As illustrated in FIG. 1, a transmission of content begins with a server 105, such as a voice-over IP server, computer server, or like device for implementing symmetrical service, which generates content for transmission via a communication path 110 to an ATM switch 115 that supports inverse multiplexing over ATM. As shown in FIG. 1, the server 105 and ATM switch 115 are located on a high-speed network of the content provider 120. The ATM switch 115 organizes the content, received in the form of a digital data stream, into 53-byte cell units for transmission over a physical medium, as is well known in the art. In the system 100 illustrated in FIG. 1 each cell is individually processed asynchronously relative to other cells, and is typically queued before being inverse multiplexed and transmitted from the ATM switch 115 to a ATM network 125.

As shown in FIG. 1, the ATM switch 115 transmits the inverse-multiplexed data stream using the ATM network 125 to an ATM switch 130 that supports Inverse Multiplexing over ATM. The ATM network 125 may include one or more virtual circuits, such that the ATM network 125 appears as a single path though it may utilize resources from multiple circuits such that the ATM network 125 does not create a bottleneck in the system 100. Because ATM is designed to be easily implemented by hardware, faster processing and switch speeds are possible, with speeds on ATM networks reaching 10 Gbps. The ATM switch 130 is typically located at a central office 135 or like location that is operative to further distribute the content via multiple high speed paths, such as T1 lines 140 in the system 100 illustrated in FIG. 1.

Generally, inverse multiplexing speeds up data transmission by dividing a data stream into multiple concurrent streams that are transmitted at the same time across separate channels, such as the T1 lines 140 shown in FIG. 1. The streams are then reconstructed at the other end back into the original data stream. Inverse multiplexing therefore seeks to alleviate a bottleneck created by a slower line between two high-speed networks. For instance, in the system 100 of FIG. 1, inverse multiplexing is used to transmit content, such as video, from the central office 135 to a client LAN 160 across the bottleneck created by the transmission line connecting the central office 135 to the client LAN 160. Rather than using a single “slow” line such as a T-1 (1.544 Mbps), inverse multiplexing the cells allows the content to be transmitted over the three separate T1 lines 140 simultaneously. Because the content is load-balanced across all of the T1 lines 140, and each T1 line can handle approximately 1.5 Mbps, the three T1 lines 140 generate an effective path of 4.5 Mbps. However, a single application can only effectively use one T-1 line, at 1.5 Mbps, at any time.

The T1 lines 140 terminate at an ATM switch 145. After receiving the cells that form the data stream, the ATM Switch 145 recovers the data stream transmitted by the server 105 by reconstructing the cells transmitted through the ATM network 125, as is well known in the art. Finally, the ATM Switch 145 transmits the data stream embodying the content to its desired recipient computer system 155, which is local to the ATM Switch 145 and in high speed communication (e.g., >4.5 Mbps) 150 with the ATM switch 145 on a client LAN 160.

The content distribution system 100 shown in FIG. 1 was designed for delivering two-way voice conversations. Voice conversations, which typically require little bandwidth, are symmetrical and require low latency and low jitter in both the upstream and downstream directions. High quality video data streams, on the other hand, are asymmetrical (much more data goes downstream than upstream) and can have significant latency and jitter given enough buffer space within a recipient's video display device. Therefore, low latency, low jitter symmetrical voice service requires a more expensive constant bit rate (CBR) service while video can be provided over less expensive asymmetrical variable bit rate (VBR) or even undefined bit rate (UBR) services such as commonly provided over ADSL.

To provide enough bandwidth for high quality, compressed video streams to one or more TVs in a home, a single ADSL line is insufficient, especially when considering that HDTV (19.4 Mbps) is becoming more common. Systems and methods of the present invention overcome this problem by aggregating multiple ADSL lines to transmit bandwidth intensive content, such as digital video, with high quality and low cost. Systems and methods of the present invention combine multiple ADSL circuits into a fully aggregated pipe to increase the maximum bandwidth available to a particular application. Thus, the present invention is operable to dedicate multiple ADSL lines to provide increase throughput available for one application. As an illustrative example, if 3 “shared” ADSL lines provide up to 1.5 Mbps each, the shared ADSL lines may be aggregated to provide a single application 4.5 Mbps.

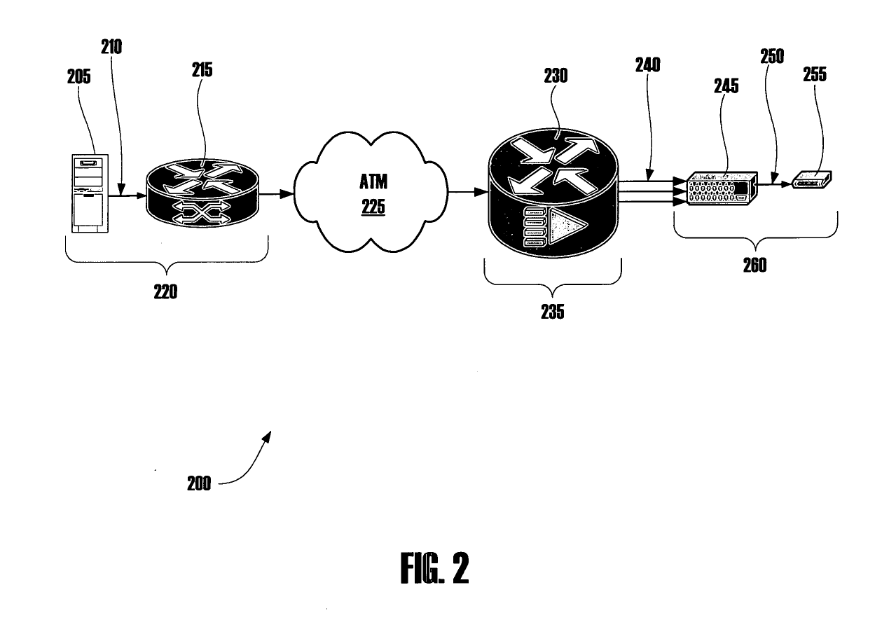

FIG. 2 shows a block diagram illustrating a system 200 in which ADSL lines are aggregated, according to one embodiment of the present invention. In particular, the system 200 of FIG. 2 is useful in delivering video content because video content, like the ADSL lines which carry it, is highly asymmetric. ADSL, as is known in the art, transmits digital content at a high bandwidth using existing telephone lines and is asymmetric because it uses most of a communication path to transmit downstream to the user and only a small part to receive information from the user. Because ADSL accommodates voice information simultaneously with digital content it is an always-on connection that does not interrupt conventional telephone service. Although ADSL is typically only offered within eighteen thousand feet from a central telephone office, it generally offers downstream data rates from 512 Kbps up to about 6 Mbps at relatively low cost in comparison to T1 lines and their equivalent.

Referring again to FIG. 2, the transmission of content using the systems and methods of the present invention begins with a server 205, such as a video on demand (VoD) server or like device, which generates content. The system 200 transmits the content to an end-user device, such as a STB 255, using ATM Protocol, as is well known in the art. The content is transmitted in the form of a data stream via a communication path 210 to an ATM switch 215 that supports Inverse Multiplexing over ATM. ATM switches like the ATM switch 215 in the system of FIG. 2 are also commonly referred to as routers with inverse multiplexing over ATM support, and are commercially available from manufacturers including Cisco™, Laurel Networks™, Larscom™, and Mindspeed™.

According to one embodiment of the present invention, the server 205, communication path 210 and ATM switch 215 are located on a LAN at a data center 220 that generates content. The ATM protocol uses fixed size packets, each containing a 5 byte header and a 48 byte payload. Thus, like the ATM switch 115 of FIG. 1, the ATM switch 215 organizes the content received in the form of digital data into 53-byte cell units for transmission over a physical medium. Because ATM protocol is connection oriented, meaning that a fixed path must be set up between a transmitting and receiving party (similar to telephone networks), the ATM switch 215 must identify and set up at least one transmission path by which the ATM data cells will be transmitted to their destination, the STB 255.

In the system 200 illustrated in FIG. 2, each cell is individually processed asynchronously relative to other cells, and is typically queued before being inverse multiplexed and transmitted from the ATM switch 215 to the ATM network 225. According to one embodiment of the present invention, the ATM switch 215 inverse multiplexes the data stream into cell units over multiple virtual circuits. For example, the data stream carrying video content may be inverse multiplexed such that three virtual circuits carry portions of the data stream. It will be appreciated that any number of virtual circuits may be used. The ATM network 225 shown in FIG. 2 may therefore include one or more virtual circuits, such that the ATM network 225 appears as a single path though it may utilize resources from multiple circuits such that the ATM network 225 does not create a bottleneck in the system 200. Because ATM is designed to be easily implemented by hardware, fast processing and switch speeds are possible, with speeds on ATM networks reaching 10 Gbps.

The ATM switch 215 transmits the inverse-multiplexed data using one or more predetermined paths through the ATM network 225 and to a digital subscriber line access multiplexer (DSLAM) 230. According to one embodiment of the present invention, the DSLAM 230, as is known in the art, is located at a central office 235, such as a telephone company central office. The DSLAM 230 receives data from each virtual circuit and modulates the virtual circuit onto an ADSL path, as is well known in the art. Descrete Multitone (DMT) modulation, which is often referred to as orthogonal frequency division multiplexing (OFDM), may be used, as well as Quadrature Amplitude Modulation (QAM) or Carrierless Amplitude/Phase (CAP) modulation, as are known in the art. Because ATM protocol is used the DSLAM 230 knows the destination(s) to send the data received from the virtual circuits. The DSLAM 230 modulates each virtual circuit to corresponding ADSL paths 240, such that the data stream broken up via inverse multiplexing by the ATM switch 215 is distributed over the same number of ADSL paths as the number of virtual circuits carrying the inverse multiplexed data over the ATM network 225. According to another embodiment of the present invention, the DSLAM 230 is also operable to distribute data received by one or more circuit paths equally over the available ADSL paths, such that the virtual circuits and ADSL paths 240 are not in one to one relationship. For instance, the DSLAM 230 may modulate more than one virtual circuit onto a single ADSL path, as known to those of ordinary skill in the art.

In the illustrative embodiment of FIG. 2, the system 200 includes three ADSL paths 240, each carrying approximately 1.5 Mbps. Because three ADSL paths are located between the central office 235 and a client LAN 260 to which the content is transmitted, the content is load-balanced across all of the ADSL paths 240, generating an effective communication path of 4.5 Mbps. Although three ADSL paths 240 are illustrated in the system 200 shown in FIG. 2, it should be appreciated that any number of ADSL paths may be used in aggregate to effectively increase the throughput of the communication path between the DSLAM 230 and client LAN 260.

As illustrated in FIG. 2, the ADSL paths 240 transmitting data from the central office 235 to the client LAN 260 are received by an ADSL modem 245 in high speed communication 250 (e.g., >4.5 Mbps) with a recipient STB 255 to which the content is transmitted. In conjunction with software operating therewith, the ADSL modem 245 reconstructs the content from the multiple ADSL data streams received from the DSLAM 230 such that the STB 255 receives the content transmitted by the server 205. The ADSL modem 245 reconstructs the ADSL data streams by grabbing data from each ADSL modem 245 and re-multiplexing the data before it is transmitted over Ethernet. The opposite or reverse occurs for communications back to the server 205.

As described above with respect to the embodiment shown in FIG. 2, the server 205, communication path 210 and ATM switch 215 are located on a LAN at a data center 220 that generates content. According to another embodiment of the present invention, the ATM switch 215 need not be located local to the server 205. The ATM switch 215 may be located at the central office 235 or within the DSLAM 230. If the switch 215 is located within the DSLAM, this may require a dedicated inverse multiplexing blade for the DSLAM 230. It will be appreciated that the location of the ATM switch 215 is dependent only on ATM circuit provisioning. Therefore, although in FIG. 2 the ATM switch 215 is placed near the server 205, such that it could be controlled with the server 205 at the data center 220, the ATM switch 215 may also be controlled by a Telco or ADSL provider, i.e., local to the DSLAM 230 or local to the central office 235.

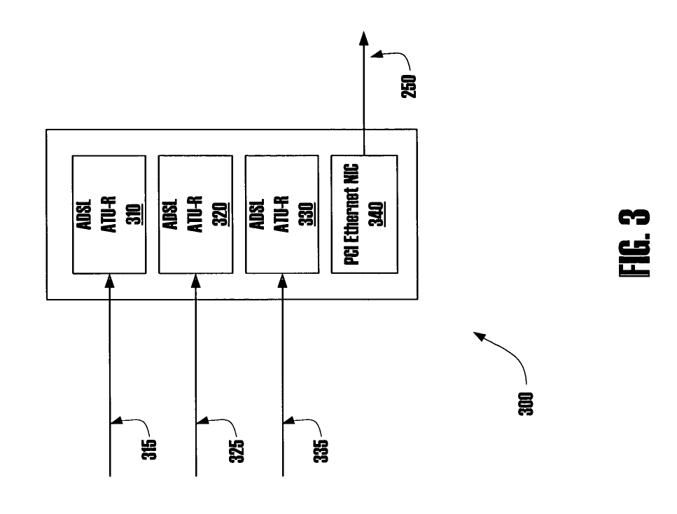

FIG. 3 shows a block diagram illustrating an ADSL modem 300 for multiplexing data received via aggregated ADSL lines, according to one embodiment of the present invention. In general, ADSL transmits digital information at a high bandwidth on existing phone lines, where voice communications are carried in a low frequency band, and upstream and downstream digital communications are carried at higher frequency bands, respectively. ADSL therefore may simultaneously accommodate analog (e.g., voice) information on the same line as digital information. ADSL is asymmetric in that it uses most of the channel to transmit downstream to the user and only a small part to receive information from the user.

Referring again to FIG. 3, the ADSL modem 300 is a hardware unit that operates in conjunction with software (not illustrated) to acquire digital data transmitted at high frequencies over one or more ADSL paths. Because the ADSL paths utilize plain old telephone service (POTS) lines, the ADSL modem 300 connects 250 to the STB 255 via a peripheral component interconnect (PCI) Ethernet network interface card (NIC) 340, and on the other side, to one or more a telephone jacks to receive the POTS lines containing the ADSL. According to another embodiment of the invention, the ADSL modem 300 may connect 250 to the STB 255 via a VersaModule Eurocard (VME) bus, Multibus, bus, or like device known to those of skill in the art. Additionally, according to one aspect of the present invention, the ADSL modem 300 may also be hooked up to one or more signal splitters that divide the POTS signals for each line into low frequencies for voice and high frequencies for data.

In the illustrative embodiment shown in FIG. 3, the ADSL modem 300 includes three separate peripheral component interconnect ADSL Termination Units (ATU-Rs) 310, 320, 330 corresponding to respective ADSL paths 315, 325, 335 (collectively, 240). Inexpensive ATU-Rs are well known for terminating an ATM virtual circuit. However, in this illustrative example the inverse multplexing ADSL modem utilizes three ATU-Rs in a cumulative fashion. Because multiple ADSL lines terminate at the inverse multiplexing ADSL modem 300, where the ADSL lines carry cell units that must be collectively recombined in appropriate order to regenerate the data stream, and thus, content transmitted by a server, the ADSL modem 300 reconstructs the data streams. Because ATM protocol is used, the ADSL line reconstruction order may be determined when the phone lines are connected. Specifically, an installer must configure the lines properly so that the correct order is obtained. However, to make installation easier, the ADSL modem 300 may be operable to test the connections to determine the correct order automatically, which may be done by evaluating the data until a valid checksum is obtained.

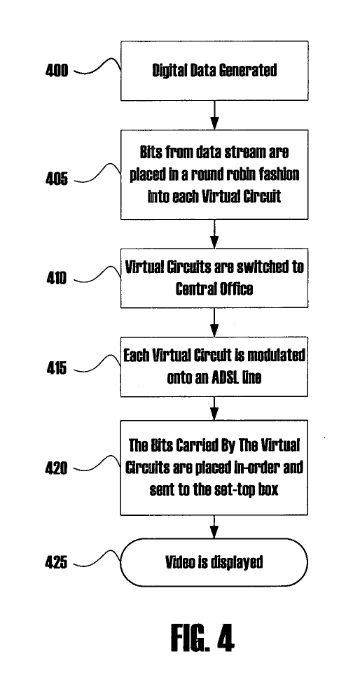

FIG. 4 shows a block diagram flow chart illustrating a method in which digital content is transmitted via aggregated ADSL lines, according to one embodiment of the present invention. As shown in FIG. 4, the process beings with the creation of digital data, e.g., video data (block 400), by a content provider. Thereafter, the digital data is transmitted via a local high speed connection to an ATM switch supporting inverse multiplexing over ATM. Bits from the digital data are placed in a round-robin fashion into virtual circuits identified by the ATM switch (block 405). The bits are then transmitted via the virtual circuits.

Next, each virtual circuit is modulated onto a corresponding ADSL line (block 415) for transmission to the client recipient of the digital data. It should be appreciated that in ATM systems there are two types of circuits, permanent virtual circuits (PVCs) and switched virtual circuits (SVCs). A permanent virtual circuit purchased from a Telco is typically used to connect data lines. A line from a first location to a second is “nailed up” with a specified quality of service (QoS) and remains there until “torn down”. SVCs can also be used for data but typically have not worked well for that purpose. The best example of an SVC is a telephone call, where an ATM network uses a phone number to create a switched virtual circuit between two points. In the present invention, either a PVC or an SVC may be used, though a PVC is preferred. For a PVC, the Telcos would nail-up a circuit for each customer site to an ATM switch with inverse multiplex blades. After transmission over the ADSL lines, the bits from each line are placed in order by the ADSL modem and are transmitted to the recipient computer or STB (block 420), after which the data may be displayed (block 425).

Many modifications and other embodiments of the inventions set forth herein will come to mind to one skilled in the art to which these inventions pertain having the benefit of the teachings presented in the foregoing descriptions and the associated drawings. Thus, it will be appreciated by those of ordinary skill in the art that the present invention may be embodied in many forms and should not be limited to the embodiments described above. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for transmitting data from a source to a destination, comprising:
providing digital data;
inverse-multiplexing said digital data into a plurality of Asynchronous Transfer Mode (ATM) data cells;
identifying at least one transmission path by which said plurality of ATM data cells are transmitted to a destination;
transmitting said plurality of ATM data cells to said destination using, at least in part, a plurality of Asymmetric Digital Subscriber Lines (ADSL); and
receiving said ATM data cells at said destination.

2. The method of claim 1, further comprising the step of multiplexing said ATM data cells to reconstruct, at said destination, the digital data.

3. The method of claim 2, further comprising the step of displaying the digital data.

4. The method of claim 1, wherein the step of transmitting further comprises the step of transmitting said plurality of ATM data cells to said destination using, at least in part, an ATM network.

5. The method of claim 1, wherein the step of transmitting further comprises the step of transmitting said plurality of ATM data cells to said destination using, at least in part, a virtual circuit.

6. The method of claim 5, further comprising the step of modulating the virtual circuit onto an ADSL.

7. The method of claim 1, further comprising the step of reconstructing said ATM data cells to reconstruct the digital data using an ADSL modem.

8. The method of claim 1, wherein the step of identifying at least one transmission path comprises the step of identifying at least one transmission path using ATM protocol.

9. A system for distributing bandwidth-intensive content, comprising:
a content provider operative to provide digital data;
an ATM switch, in electrical communication with said content provider, wherein said ATM switch is operative to inverse-multiplex said digital data into a plurality of data cells;
at least one predefined transmission path by which said plurality of data cells may be transmitted to a destination; and
at least two Asymmetric Digital Subscriber Lines (ADSLs), wherein said ADSLs are operable to forward said plurality of data cells to said destination.

10. The system of claim 9, further comprising at least one ATM network in communication with said ATM switch, wherein said ATM network is operable to transmit at least a portion of said digital data via at least one virtual circuit.

11. The system of claim 9, further comprising at least one ADSL modem, wherein said at least one ADSL modem is operable to reconstruct the plurality of data cells.

12. The system of claim 9, further comprising at least one DSLAM, wherein said at least one DSLAM is operable to receive data from a virtual circuit and to modulate the virtual circuit onto an ADSL path.

13. The system of claim 9, wherein the content provider comprises a video on demand server.

14. The system of claim 9, wherein the content provider and ATM switch are in communication via a local area network.

15. The system of claim 14, wherein the aggregate transmission speed of the at least two ADSLs at least equals the transmission speed of the local area network.
